(19) United States
(12) Patent Application Publication
(10) Pub. No.: US 2015/0144065 A1
(43) Pub. Date: May 28, 2015

(54) SNACK STACK BIRD FEEDER

(71) Applicant: JK LAWN & GARDEN SUPPLIES, INC., Fremont, CA (US)

(72) Inventor: Weichiat Chen, Fremont, CA (US)

(21) Appl. No.: 14/090,841

(22) Filed: Nov. 26, 2013

(51) Int. Cl. A01K 39/01

(52) U.S. Cl. CPC A01K 39/0106
USPC 119/51.03

(57) ABSTRACT

Bird feeding devices are provided that include a base having a substantially flat upper surface, a pillar having a bottom end and an upper end, wherein the pillar extends upward from the base with the bottom end connected to the base at a location proximate the center of the upper surface, a roof disposed above the base and connected to the upper end of pillar, and a stand connected to the base at a location proximate an edge of the base, wherein the stand extends, around the pillar, towards the roof (i) for at least one third of a distance between the base and the roof and (ii) for at least three quarters of a circle, and wherein the stand comprises two or more perches, wherein the pillar is configured to slidingly receive one or more bird feed tablets.

### BACKGROUND

Bird feeder is a common landscaping device that is placed outdoors to supply food to birds. Bird feeders can attract birds of various types, depending on the food supplied in the feeder, and thus are often used for bird watching. To be both attractive to birds and appealing to birdwatchers, bird feeders should be aesthetically pleasing.

Seed feeders are the most common type. These can vary in design from tubes to hoppers and trays. Sunflower seed or mixed seed are popular for use in these feeders and will attract many songbirds such as cardinals, finches, and chickadees. Black Oil Sunflower seed is especially popular with bird enthusiasts. Most bird feeders are designed to dispense sunflower-sized foods, but there are specialty “finch feeders” with smaller openings to dispense the tiny Niger seed, which is a favorite of smaller finches.

Certain bird feeders supply liquid nourishment, rather than dispensing seed, to birds such as hummingbirds. This liquid nourishment is often colored red to attract birds. Yeasts tend to grow in hummingbird feeders and spoil the solution, so they should be refreshed frequently and kept clean to avoid harm to the birds.

Another type of bird feeder is oriole feeder which supplies artificial nectar and is designed to serve New World orioles, which have an unusually shaped beak and tongue. Oriole feeders usually have nectar containers made of glass or plastic. Yet another type is suet feeder which is typically a metal cage-like construction with a plastic coating that contains a cake or block of suet to feed woodpeckers, flickers, nuthatches, and many other species of insect eaters. Suet logs are also very common. These wooden logs have holes drilled out for suet to be inserted.

Feeding wild birds does carry potential risks. Birds may contract and spread disease by gathering at feeders; poorly maintained feeding and watering stations may also cause illness. The conventional bird feeders, however, are difficult to clean in particular inside the containers or other types of enclosures for storing the food. There is a need, therefore, for bird feeders that are easy to clean and maintain and are aesthetically appealing to birds and birdwatchers.

### SUMMARY

The disclosure, in one embodiment provides a bird feeding device comprising a base having a substantially flat upper surface, a pillar having a bottom end and an upper end, wherein the pillar extends upward from the base with the bottom end connected to the base at a location proximate the center of the upper surface, a roof disposed above the base and connected to the upper end of pillar, and a stand connected to the base at a location proximate an edge of the base, wherein the stand extends, around the pillar, towards the roof (i) for at least one third of a distance between the base and the roof and (ii) for at least three quarters of a circle, and wherein the stand comprises two or more perches, wherein the pillar is configured to slidingly receive one or more bird feed tablets. In some aspects, the device does not include cups for holding food for bird feeding.

In some aspects, the perches are substantially evenly distributed along the stand. In some aspects, the perches are from about 0.5 inch to about 2 inches in diameter or longest dimension. In some aspects, the perches extend from the stand upward and/or outward. In some aspects, the perches are at least partially twisted or folded. In some aspects, the device includes three or four perches. In some aspects, the perches have a shape of a ring or a leaf or is round or oval.

In some aspects, the stand extends for a full circle. In some aspects, the stand is spiral. In some aspects, the stand has one or more straight edges. In some aspects, the pillar is removable from the base. In some aspect, the roof is removable from the pillar.

In some aspects, the base has a plurality of perforations. In some aspects, the base is substantially round. In some aspects, the base is from about 2 inches to about 18 inches in diameter, or from about 3 inches to about 15 inches, or from about 4 inches to about 12 inches, or from about 5 inches to about 10 inches in diameter,

In some aspects, the pillar is from about 4 inches to about 24 inches long, or from about 4 inches to about 18 inches long, or from about 5 inches to about 15 inches long, or from about 5 inches to about 12 inches long.

In some aspects, the feeder further comprises a circular head removably attached to the roof. In some aspects, feeder further comprises a connector having at one end a ring for connecting to the circular head and a hook at another end.

### BRIEF DESCRIPTION OF THE DRAWINGS

Provided embodiments are illustrated by way of example, and not limitation, in the figures of the accompanying drawings in which:

FIG. 1 is a perspective view of one embodiment of the bird feeder of the present disclosure;

FIGS. 2 and 3 present front side views of the bird feeder, with FIG. 3 showing that the roof is detached from the pillar, and the roof head is detached from the roof;

FIG. 4-7 are enlarged views of the hook (FIG. 4), the roof head (FIG. 5), the roof (FIG. 6) and the connector (FIG. 7);

FIG. 8 presents a bird eye view of the bird feeder under the roof;

FIG. 9 presents a perspective view of the bird feeder without the roof;

FIGS. 10 and 11 present two side views of the bird feeder without the roof, from two different angles;

FIG. 12-15 show the rings from different perspectives; and

FIG. 16 is a picture of the bird feeder loaded with donut-shaped bird food tablets.

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION

As used herein, certain terms have the following defined meanings. Terms that are not defined have their art recognized meanings.

As used in the specification and claims, the singular form “a”, “an” and “the” include plural references unless the context clearly dictates otherwise.

As used herein, the term “comprising” is intended to mean that the devices include the recited elements, but not excluding others. “Consisting essentially of” when used to define compositions and methods, shall mean excluding other elements that would materially affect the basic and novel characteristics of the device. “Consisting of” shall mean excluding any element, step, or component not specified in the claim. Embodiments defined by each of these transition terms are within the scope of this disclosure.

The present disclosure provides bird feeders that load bird food tablets of cylindrical shape, in particular those having premade openings (e.g., donut-shaped tablets). The bird feeder, also referred to as a “snack stack bird feeder,” includes a pillar that can slidingly receive one or more such bird food tablets. The bird feeder can be easily cleaned after the bird food is consumed by birds or removed by a maintainer, to reduce the chance of diseases being spread among birds. The design is also aesthetically appealing to birds and birdwatchers.

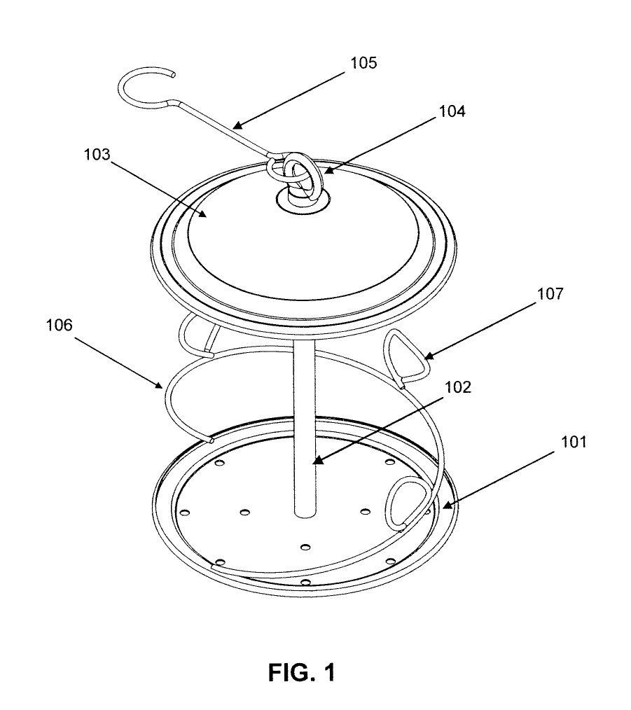

FIG. 1 illustrates one embodiment of the bird feeder of the present disclosure. As shown in FIG. 1, the bird feeder includes a base (101), a roof (103) and a pillar (102) connecting the two. Furthermore, the bird feeder includes a stand (shown as a spiral stand, 106) that is connected to the base at a location proximate an edge of the base and extends, around the pillar, towards the roof. Along the way from the base to the upper end of the stand, the stand is attached to, or is formed with, two or more perches (shown as rings, 107) for birds to stand on.

### The Base Unit

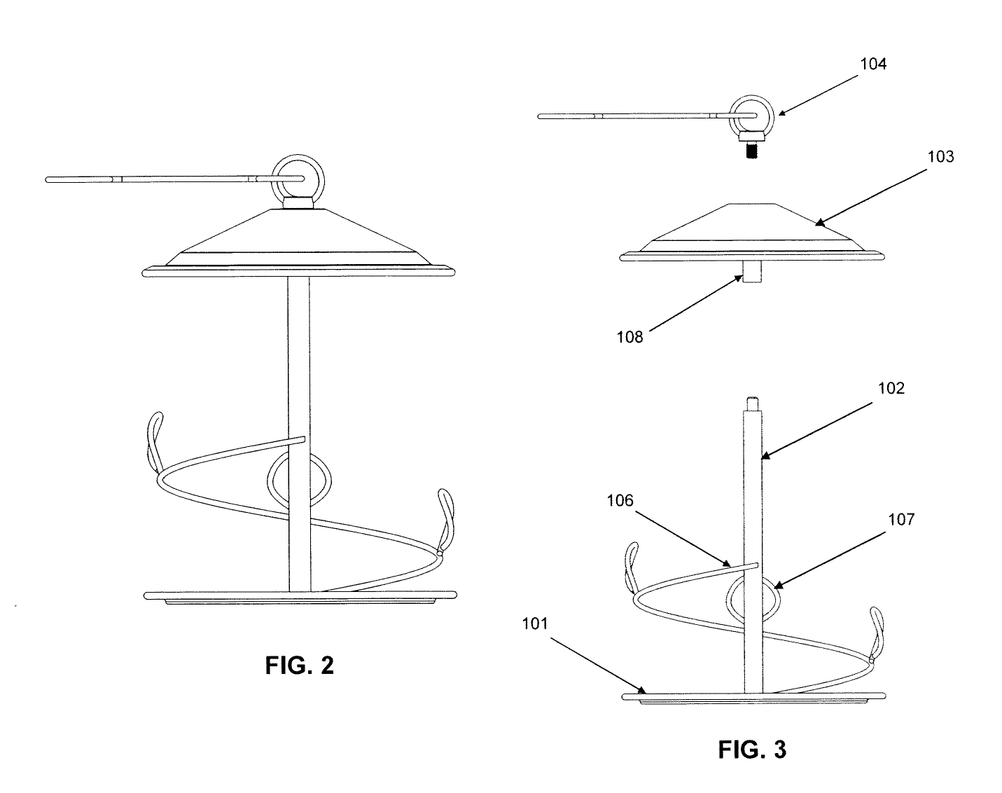

The base (101), in some aspects, has a substantially flat upper surface for holding the donut-shaped bird food tablets. Such a flat upper surface is more apparent in FIGS. 2 and 3, which present the side views of the bird feeder. A “substantially flat” surface, as used herein, refers to a surface that has a surface area not greater than about 120%, 110% or 105% (each ±10%) of the projected area of the surface.

In some aspects, the base has a substantially flat bottom surface which is useful when the bird feeder is placed on a platform having a flat top. In some aspects, the bottom surface is slightly smaller than the upper surface. For instance, the bottom surface is from about 80% to about 95% of the size of the upper surface.

In some aspects, the base is relatively thin. That is, the height of the base is less than about 10%, or alternatively about 5%, or 2% of the height of the bird feeder when assembled.

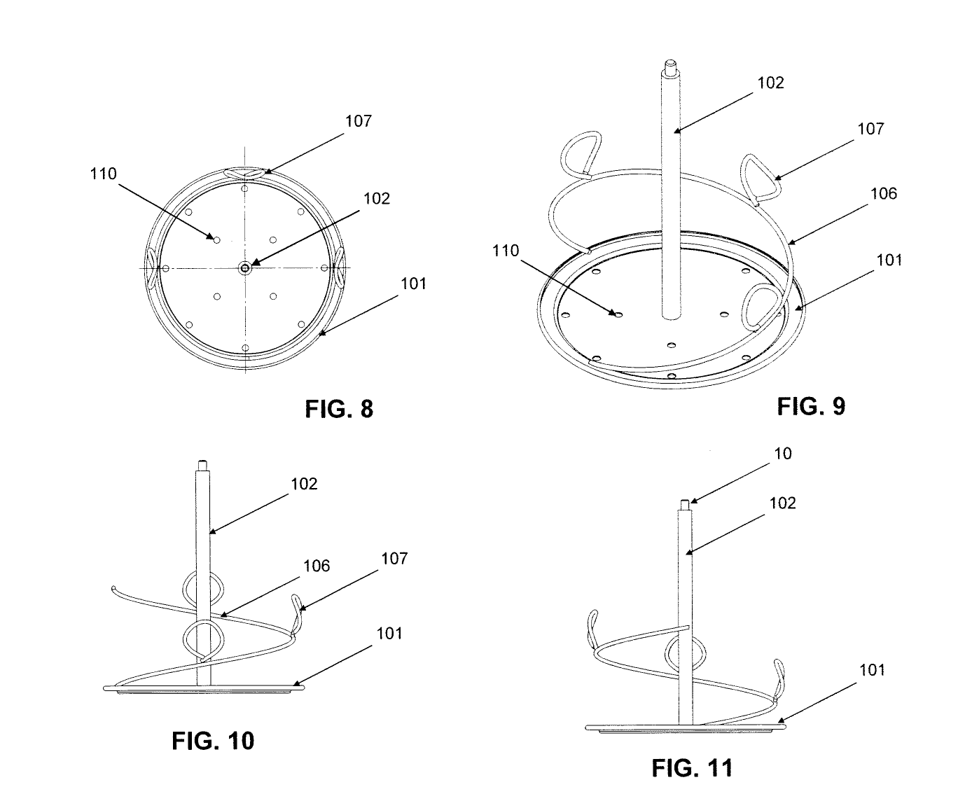

In some aspects, the base contains a plurality of perforations (illustrated as 110 in FIGS. 8 and 9) to allow water to flow through. This is helpful to keep the food dry when in a wet condition. In some aspects, the number of perforations in the base is from 4 to about 50, or from about 8 to about 20. In some aspects, each perforation is substantially round. In some aspects, each perforation is from about 2 mm to about 10 mm, or from about 4 mm to about 8 mm, or from about 5 mm to about 7 mm, in diameter.

In some aspects, the base is round. In some aspects, the base can also take the shape of square, hexagonal or octagonal, without limitation.

### The Roof Assembly

The bird feeder also includes a roof assembly disposed above the base unit. This roof assembly serves the purpose of (1) shielding the bird food from rain or other types of precipitation from above, (2) providing a mechanism to hang the bird feeder on the tree or other scaffold, (3) securing the food tablets between the base and the roof, (4) rendering a balanced look of the bird feeder, and (5) preventing rodents from reaching the bird food.

In some aspects, the roof assembly includes a roof (see 103 in FIG. 3) that is, optionally removeably, connected to the upper end of the pillar. The roof can have a bottom surface and a upper surface. The bottom surface of the roof, in one aspect, has an area that is the same as or greater than the area of the base, so as to provide adequate shield from the rain. The shape of the roof can also be round, square, hexagonal or octagonal, without limitation. In some aspects, the upper surface of the roof has an elevated center and lowered edges.

The roof can be connected to the upper end of the pillar with a locking mechanism. One non-limiting example of the locking mechanism includes a connector (108 in FIG. 3) having internal threads matching external threads on the upper end of the pillar (see upper end of 102 in FIG. 3; thread not shown). Other locking mechanisms include two dimples on the female connector and grooves on the male connector, or with a pin pressed into a female connector and two milled out grooves on a male connector (not shown).

The roof assembly, in some aspects, further includes a roof head (104 in FIG. 3) that has external threads (shown in FIG. 5) also matching the internal threads of the connector (108 in FIG. 3 and FIG. 7). Therefore, the roof head can be connected to the connector, through an opening (shown in FIG. 6) at the center of the roof, securing the roof to the pillar. In some aspects, the roof head can be pressed (interference fit) into the connector or welded to the connector.

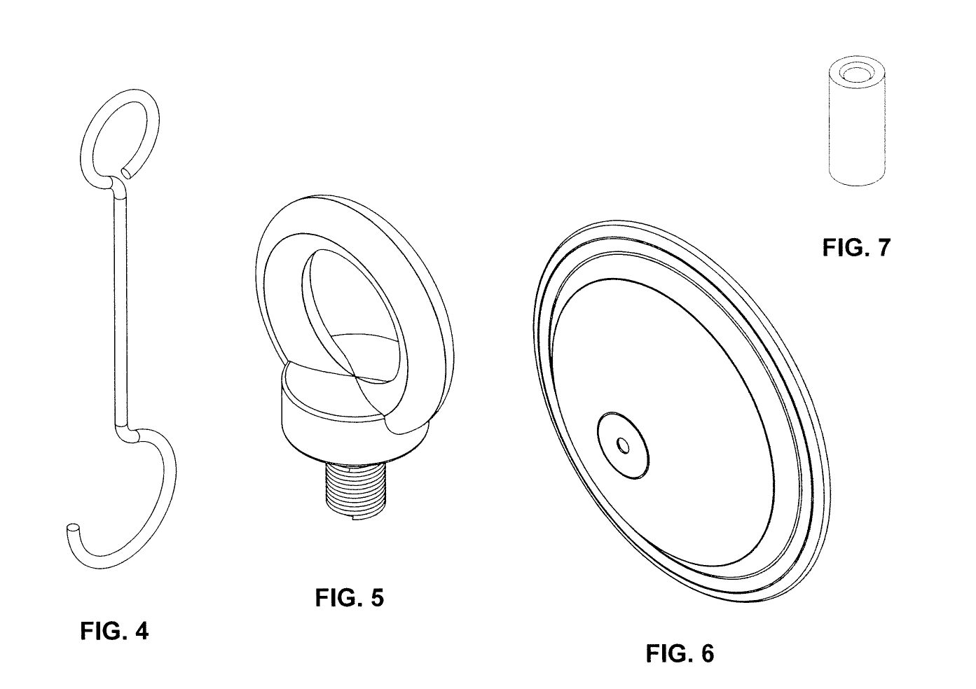

In some aspects, the roof assembly further includes a hook (105 in FIG. 1 and FIG. 4) for hanging the bird feeder to, e.g., a branch of a tree.

### The Pillar and the Stand

The bird feeder, in one embodiment, includes a pillar that connects the roof assembly and the base. In one aspect, the connection between the roof assembly and the pillar is detachable so that the roof can be removed to load donut-shaped bird food to the feeder. In one aspect, the connection between the pillar and the base is detachable to allow loading of the bird food and/or easy cleaning of the feeder.

In some aspects, the pillar (102 in FIG. 8) is connected to the center of the base, extending upright so that the pillar is perpendicular to the upper surface of the base. As the pillar is also perpendicular to the bottom of the roof, the upper surface of the base and the bottom of the roof can be parallel.

In some aspects, the pillar is configured to be able to slidingly receive donut-shaped bird food tablets. That is, the pillar does not have branches or attachments of significant sizes. In one aspect, the pillar has no branch or attachments larger than the pillar's own horizontal dimension. In one aspect, the pillar has no cups, containers, or hooks attached to the side of the pillar to hold bird food.

The pillar, in one aspect, has a cylindrical shape. In another aspect, the pillar has a horizontal cross section that is square, hexagonal or octagonal, without limitation. In some aspects, the cross sectional area of the pillar is no greater than about 20%, 15%, 10% or 5% of the area of the upper surface of the base. In some aspects, the pillar is thick enough (e.g., at least about 5 mm, 8 mm, 12 mm, or 14 mm in diameter). It is to be understood that the pillar does not need to have uniform cross section size but can be thinner or thicker at the upper end than the lower end, without limitation, so long as it allows food tablets to be slidingly loaded or removed.

In one embodiment, the bird feeder includes one or more stand that extends from the base. The stand, at the lower end, is attached to the base, optionally permanently, to ensure stable connection. In one aspect, the attachment is made at a location of the base that is close to the edge. The stand extends upwards towards the roof in a, e.g., spiral fashion around the pillar, so as to provide a platform for birds of different size to reach bird food of different elevation within the bird feeder. For instance, birds that stand the upper end of the stand can reach food tablet at the top whereas those at the lower end can easily reach the lower tablets. Larger birds, however, can still reach the tablets on the top while standing low.

In some aspects, the stand extends to cover at least one quarter of a distance between the base and the roof. In some aspects, the stand travels, horizontally, for at least three quarters of a circle, or at least 90%, 100%, 110%, 120% or 150% of a circle. In some aspects, the stand extends to cover at least about one third, two fifths, or a half of the distance between the base and the roof. In some aspects, the stand is spiral. In some aspects, the stand comprises one or more straight edges, such as to form a shape of square, hexagonal or octagonal when viewed from above.

In another embodiment, the bird feeder includes two or more perches for birds to stand on (107 in FIGS. 1-3 and 9-11), attached to the stand. The perches are configured to have a shape and to be placed at locations of the stand so as to attract birds and facilitate birds to reach the food in the feeder. In some aspects, the perches have a shape of a ring or a leaf or is round or oval. In one aspect, the perches are of a shape of rings. In one aspect, the perches extend from the stand upward and outward away from the pillar. In one aspect, the perches can be included as part of the stand.

In some aspects, the bird feeder includes at least two, or three perches but no more than five. In some aspects, the perches are evenly distributed along the stand. FIG. 8-11 illustrate a bird feeder with three perches. As indicated in FIG. 8, the three perches are each about 90 degrees, 180 degrees and 270 degrees, anti-clockwise, from the lower end of the stand, respectively.

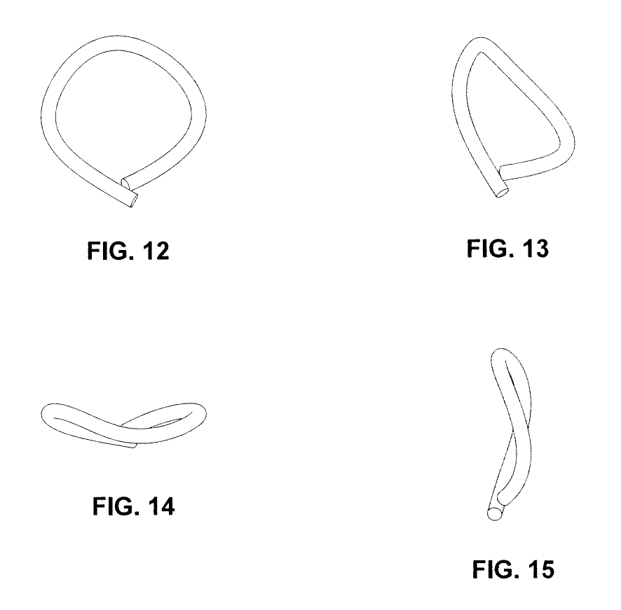

The perches, in some aspects, are of a size and shape that render aesthetic appeal to birds and birdwatchers, such as mimicking birds' natural environment. For instance, as shown from different perspectives in FIG. 12-15, the rings have two ends that slightly mismatch each other to create a natural look. Along the same line, the perches can be slightly twisted or bent. In some aspects, the perches do not extend beyond that coverage of the roof. In some aspects, each perch is about from 0.5 inch to about 2 inches in diameter or longest dimension.

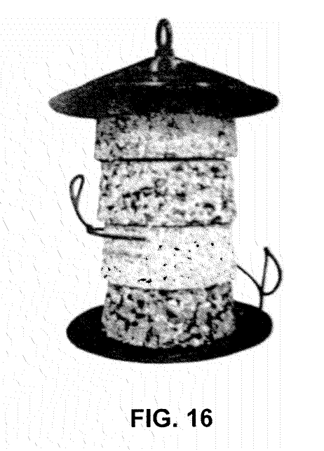

FIG. 16 presents a picture of one embodiment of the disclosed bird feeder that is loaded with stacks of bird food tablets.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A bird feeding device comprising
a base having a substantially flat upper surface,
a pillar having a bottom end and an upper end, wherein the pillar extends upward from the base with the bottom end connected to the base at a location proximate the center of the upper surface,
a roof disposed above the base and connected to the upper end of pillar, and
a stand connected to the base at a location proximate an edge of the base, wherein the stand extends, around the pillar, towards the roof (i) for at least one third of a distance between the base and the roof and (ii) for at least three quarters of a circle, and wherein the stand comprises two or more perches,
wherein the pillar is configured to slidingly receive one or more bird feed tablets.

2. The device of claim 1, wherein the device does not include cups for holding food for bird feeding.

3. The device of claim 2, wherein the perches are substantially evenly distributed along the stand.

4. The device of claim 3, wherein the perches are from about 0.5 inch to about 2 inches in diameter or longest dimension.

5. The device of claim 3, wherein the perches extend from the stand upward and/or outward.

6. The device of claim 3, wherein the perches are at least partially twisted or folded.

7. The device of claim 3, wherein the perches have a shape of a ring or a leaf or is round or oval.

8. The device of claim 3, wherein the device includes three or four perches.

9. The device of claim 2, wherein the stand extends for a full circle.

10. The device of claim 2, wherein the stand is spiral.

11. The device of claim 2, wherein the stand comprises one or more straight edges.

13. The device of claim 2, wherein the pillar is removable from the base.

14. The device of claim 2, wherein the pillar is removable from the roof.

15. The device of claim 2, wherein the base has a plurality of perforations.

16. The device of claim 2, wherein the base is substantially round.

17. The device of claim 16, wherein the base is from about 2 inches to about 18 inches in diameter.

18. The device of claim 2, wherein the pillar is from about 4 inches to about 24 inches long.

19. The device of claim 2, further comprising a circular head removably attached to the roof.

20. The device of claim 19, further comprising a connector having at one end a ring for connecting to the circular head and a hook at another end.
